(19) United States
(12) Patent Application Publication
(10) Pub. No.: US 2012/0005099 A1
(43) Pub. Date: Jan. 5, 2012

(54) Secure Electronic Records in Smart Devices

(75) Inventors: Samuel Beckey, San Ramon, CA (US); Joseph Fanelli, Escondido, CA (US); Lane Watson, Haw River, NC (US)

(73) Assignee: INTELLI-SERVICES, INC.

(21) Appl. No.: 13/048,789

(22) Filed: Mar. 15, 2011

Related U.S. Application Data
(63) Continuation-in-part of application No. PCT/US09/56853, filed on Sep. 14, 2009.

(51) Int. Cl. G06F 21/00

(52) U.S. Cl. 705/51

(57) ABSTRACT

Methods and apparatus for creating secure electronic records using a smart device are disclosed. A smart device is authorized by connecting the device with a secure host computer. The host computer authorizes the smart device for a specified period of time. The user verifies that they are allowed to use the smart device to collect and create secure electronic records. Collecting electronic records then occurs. An encrypted wrapper for each record collected is created by encrypting each record. The smart device is then reconnected to the host computer. The host computer uploads the collected records and clears the device.

### CLAIM OF PRIORITY

This application is a bypass continuation-in-part application claiming priority under 35 U.S.C. 119 and 35 U.S.C. 365(c) from international patent application no. PCT/US09/56853 filed on Sep. 14, 2009, and U.S. provisional patent application No. 61/097,135 filed on Sep. 15, 2008, both of which are hereby expressly incorporated by reference herein.

### BACKGROUND

The present disclosure relates generally to secure electronic records, and a method and apparatus for creating and maintaining formal records using electronic and digital media at a remote location away from a secure electronic environment.

The past decades have seen remarkable development of information technology. Nearly every facet of daily life and work is documented by electronic records unimaginable in earlier eras. From the typewriter to the computer, the way of work has changed, and become dependent on modem electronic technology. Many documents and work processes in many fields are now generated and stored electronically with paper records being relegated to off-site storage. Medical records, including drug and device development are now accomplished with computerized lab equipment, computer-aided design systems, and electronic record keeping. Paper records are difficult to access, store, and may degrade over time. In contrast, electronic copies of paper records offer the ease of electronic filing and easy viewing on a monitor screen.

Despite the ease and convenience of electronic documents, there is one major drawback to their use in the medical and legal environments: the validity of the documents. Because it is easy to create and modify electronic documents, it is difficult to ascertain whether an electronic document is a true and valid document. This is especially true for records submitted in conjunction with Food and Drug Administration (FDA) filings and legal proceedings. Both of these areas depend on document integrity but may have a need to incorporate the many benefits of electronic filing and storage, both for record-keeping and for official submittals.

The medical field in particular has specific needs that current electronic document creation and use methodologies are ill-equipped to handle. Both regulatory and administrative concerns have delayed the use of electronic document filing. The records that must be maintained for FDA filings include: master and batch production and control records, logs, standard operating procedures, laboratory notebooks, complaint records, validation protocols and data summaries, laboratory data summaries, and drug sample records. All of the above records must be maintained by the pharmaceutical industry and may be inspected by the FDA. Additional records may also be maintained and are subject to FDA inspection, depending on the area of research. These additional records may include: medical device history records and medical device master records, master record files, blood bank donor records, thermally processed low-acid foods records, and hazard analysis critical control points. Currently, the FDA allows certain records to be submitted in electronic form, such as: new drug or new animal drug applications, product license applications, establishment license applications, and drug or veterinary drug master files. In addition, other FDA regulated products generate records such as: with medical device pre-market approval applications, medical device pre-market notifications, medicated feed applications, food additive petitions, color additive petitions, infant formula applications, low acid canned food and acidified food firm, registration and process filing, and generally recognized as safe (GRAS) petitions. All of these submissions and inspections may require access to properly authenticated and accurate electronic documents and laboratory notes.

The legal profession also relies on electronic documents. Electronic records may be admitted in evidence to Federal Courts for use in court proceedings (see Federal Rules of Evidence 803(8)), if the record is trustworthy. Trustworthiness is established by a detailed and thorough documentation of the record keeping system's operation and the controls imposed on it. The records themselves may also need to be annotated for evidentiary purposes and managed, both of which provide challenges for an information security system. Using a smart pen, it is possible for a legal reviewer to annotate the document while the formal electronic record is being created.

However, the record created will not meet the trustworthiness standard because of the lack of security of the smart device used to collect the information and also because the electronic record may be modified or even deleted.

Recently, electronic laboratory notebooks, “smart pens” that transcribe notes directly into electronic form have come on the market, along with digital voice recorders, portable scanners, and cameras to name just a few smart devices for electronic document production away from a central electronic “home.” These smart devices enable the creation of electronic documents under a variety of settings and are easy to use and convenient. These smart devices are portable and may be used in a roaming mode away from a central computing area. Documents created by these smart devices are then downloaded to a central electronic vault upon return to a central office. The electronic vault, typically embodied as a server, represents one segment of a document management system. Intellectual property management systems, laboratory notebooks, whether in paper or electronic form exist as islands of information, distinct from secure computer environments. Multiple servers may be needed to handle the various types of electronic documents. The growing use of these smart devices poses a problem for the formal record keeping requirements in the medical, legal, and engineering professions since most smart devices, or portable devices in general offer minimal or no security. The importance of secure and trusted information systems requires security beyond that found in the typical smart device.

Creating a formal record requires more than a mere electronic copy of a paper record, or simply recording information. Formal electronic records must meet specific regulatory and evidentiary requirements for confidentiality, integrity, authentication, non-repudiation, and authorization. This is at odds with the operation scenarios of most smart devices which are not connected to a secure computing environment during use. Smart devices used in conjunction with a secure computing system need to provide their own data security while used in a roaming mode away from a secure computing system. It is preferable that the smart device be verified with the secure computing system. The need for two way security is obvious: data transferred from a “smart device” that has no data security may corrupt the entire secure computing system and subject the system to debilitating virus or other computer security attacks. Thus, there is a need for a method and apparatus for providing secure electronic records in smart devices.

### SUMMARY

Techniques for creating secure electronic records using a smart device are disclosed. A smart device is first authorized by a secure host computer. The authorization includes a time limit for the use of the smart device to collect and create secure electronic records. The user of the smart device verifies their use of the device by providing a password, or keypad entry using a stylus, fingerprint, voice print or other unique personal identifier. The smart device is then used to collect an electronic record. After the electronic record is collected, the smart device creates a secure wrapper for the newly collected record by encrypting the record. Multiple secure electronic records may be collected in this manner. Once the desired secure electronic records are collected, the smart device is reconnected to the secure host which uploads the collected records, clears the authorization and prepares the smart device for the next record collection session.

In one embodiment, a method for creating a secure electronic record using a smart device is provided. The method includes the steps of authorizing a smart device and verifying a user of the smart device. Once the user has been verified the smart device may then be used to collect an electronic record. Upon completion of the collection of one or more electronic records, the smart device is reconnected to the secure host device that initially authorized the smart device. The secure host then uploads the collected secure electronic records, clears the smart device memory, and prepares the smart device for the setup for the next session.

In a further embodiment, a processor coupled with a memory is provided. The processor is coupled with the memory, and is also configured to authorize a smart device, verify a user of the smart device, collect an electronic record, encrypt the collected record to create a wrapper for the secure electronic record, and then upload the encrypted secure electronic record to a secure host. The processor then provides for uploading the collected secure electronic records and clearing the memory of the smart device in preparation for the next data collection session.

In another embodiment, means for authorizing a smart device are provided along with means for verifying a user of the smart device. Means is also provided for collecting an electronic record using the smart device. Further means is used to create an encrypted wrapper for the electronic record collected with the smart device to create a secure electronic record. Additional means is provided for uploading the secure electronic record to a secure host and clearing the smart device memory in preparation for the next data collection session.

In yet a further embodiment, a processor readable medium including instructions thereon that may be utilized by one or more processors is provided. The processor readable medium also includes instructions for authorizing a smart device, and instructions for verifying a user of the smart device. Further instructions provide for collecting an electronic record using the smart device. Still further instructions encrypt the collected electronic record to create a secure electronic record. Additional instructions provide for uploading of the collected secure electronic records to a secure host computer or server and clearing the smart device memory in preparation for the next data collection session.

### BRIEF DESCRIPTION OF THE DRAWINGS

FIG. 1 illustrates a configuration of a secure electronics record collection system for use with smart devices in accordance with various embodiments of the present invention.

FIG. 2 illustrates a block diagram of a secure electronics record collection system for use with smart devices in accordance with various embodiments of the present invention.

FIG. 3 illustrates a flow diagram of a set up process for use in a secure electronics record collection system for use with smart devices according to an embodiment of the present invention.

FIG. 4 illustrates a flow diagram of a use process for use in a secure electronics record collection system for use with smart devices according to an embodiment of the present invention.

FIG. 5 illustrates a flow diagram of an uploading process for use in a secure electronics record collection system for use with smart devices according to an embodiment of the present invention.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident however, that such embodiment(s) may be practiced without these specific details. In other instances, well known structures and devices are shown in block diagram form in order to facilitate describing one or more embodiments.

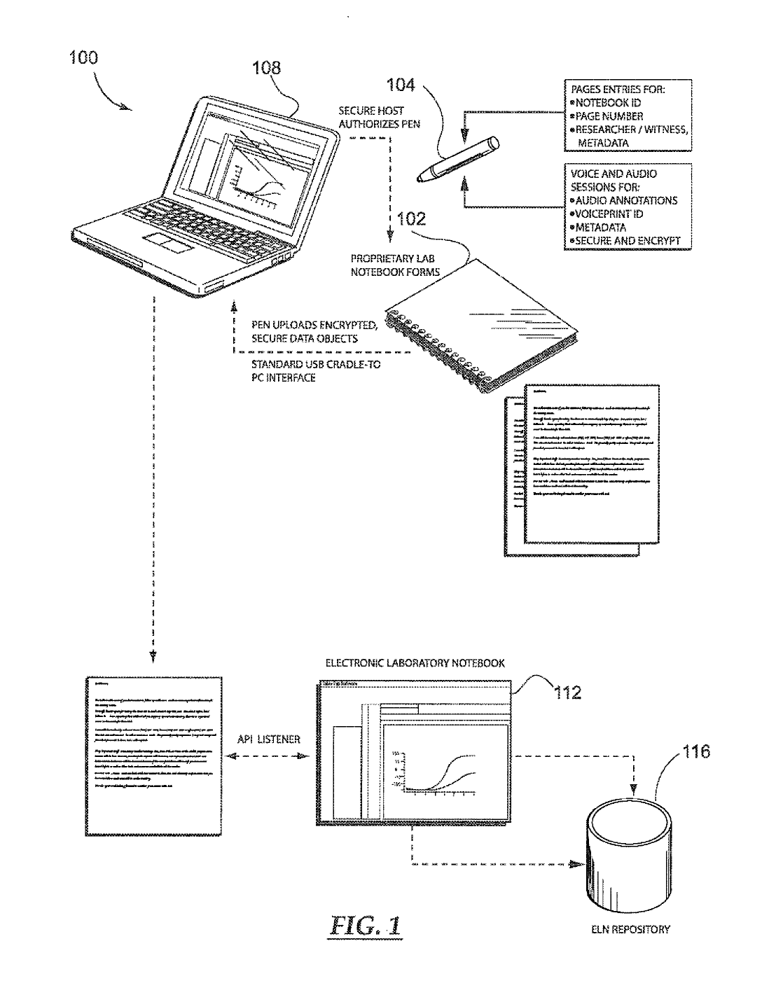

FIG. 1 illustrates a secure electronic record system 100 that provides secure use of smart devices. This secure system is designed to provide confidence that each data object, or secure electronic record created or collected by a smart device was collected by an authorized user (Authorization); has been maintained in the state in which it was originally created or collected (Integrity); cannot be copied or decoded except by the secure host (Confidentiality); is a record collected by a specific means, at a particular date and time (Authentication); and that the record cannot be erased or denied (Non-repudiation). Item 102 is proprietary forms that may be copied electronically using a smart device. These forms will vary according to the industry use and the information sought. It may also be advisable to create common tags enabling use with metadata tracking systems that are part of many database protocols. These forms may be created with a smart pen, item 104a-c, which creates an electronic record while the user writes on the form. One embodiment uses smart pens such as the Pulse™ model manufactured by Livescribe, inc. This smart device executes a computer program, such as a Java penlet application, to capture pen strokes and paper appearance. This computer program provides interaction with the user to establish data security. Any computer program operating on the selected smart device that provides similar functionality may be used. The smart pen or device 104 is authorized prior to use by the secure host 108. The smart pen or device is periodically connected to a secure server, where it is authorized for a specific user and its identity is securely established. This connection occurs before each secure record collection or creation session. The interface between the pen and the secure host may be a standard USB interface, or other interface providing the desired functionality. Documents are stored in the secure host 108 for later use and viewing by electronic laboratory notebooks 112 or other similar devices. The electronic laboratory notebook communicates with an electronic laboratory notebook repository 116. The electronic laboratory notebook 112 may also be used as a smart device in the invention.

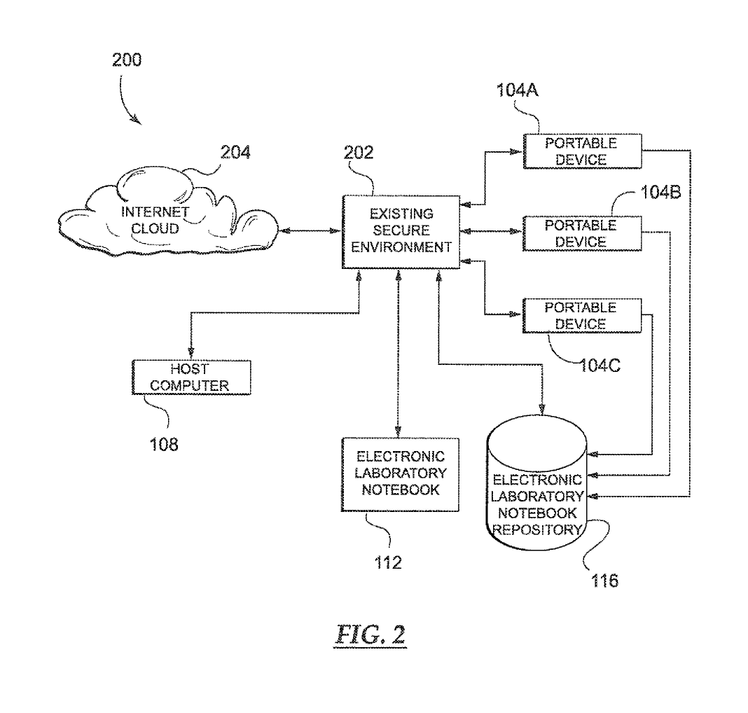

FIG. 2 illustrates a block diagram of the system depicted pictorially in FIG. 1. The block diagram 200 shows the existing secure environment 202 connected to an Internet cloud 204. This arrangement allows for transfer of documents to other secure environments or to other trusted sites as would be necessary for legal and medical document filings. The host computer 108 contains a processor and memory for running various software applications. The host computer 108 is also connected to the existing secure environment 202. An electronic laboratory notebook 112 is connected to the existing secure environment as well. The electronic laboratory notebook may also be used in conjunction with a smart device 104a-c. The smart devices are of various types such as smart pens, smart pipettes, portable scanners, cameras or similar devices. Both the electronic laboratory notebook and smart devices 104a-c are connected electronically to an electronic laboratory notebook repository, 116. The smart device 104a-c also includes a processor and memory for running applications specific to the type of data to be collected and storing the collected records. These electronic interconnections provide secure functionality of the secure electronic records in smart devices according to the embodiments of the invention.

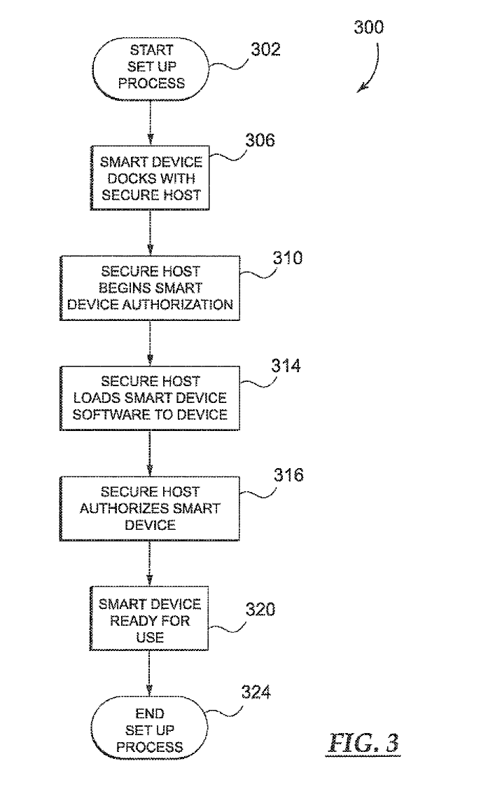

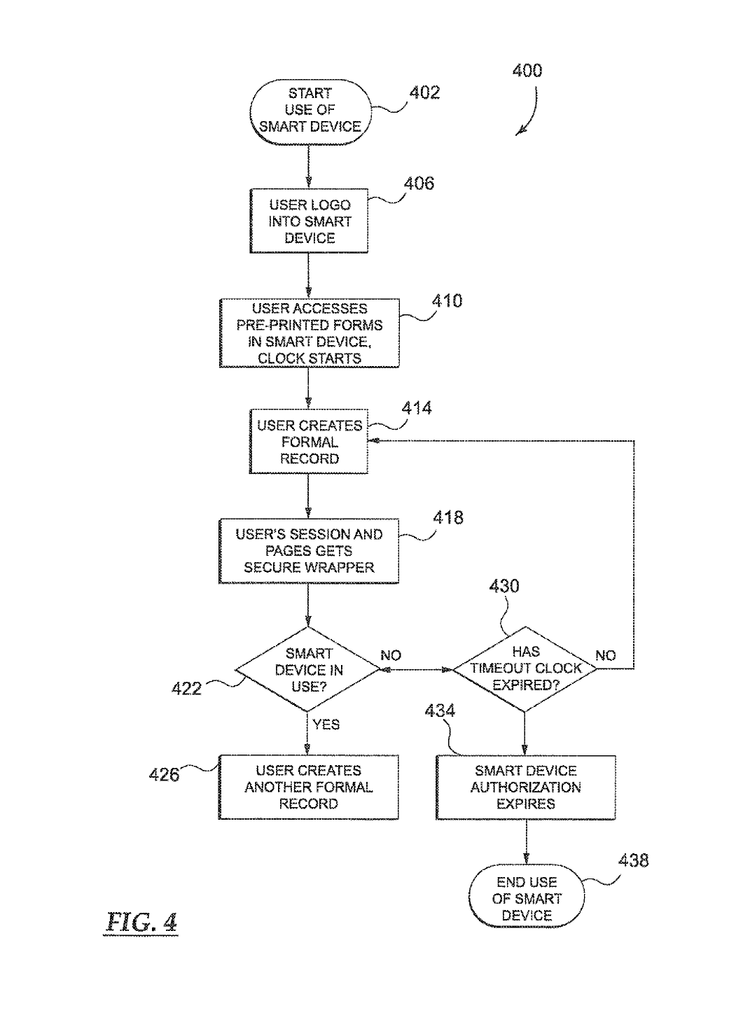

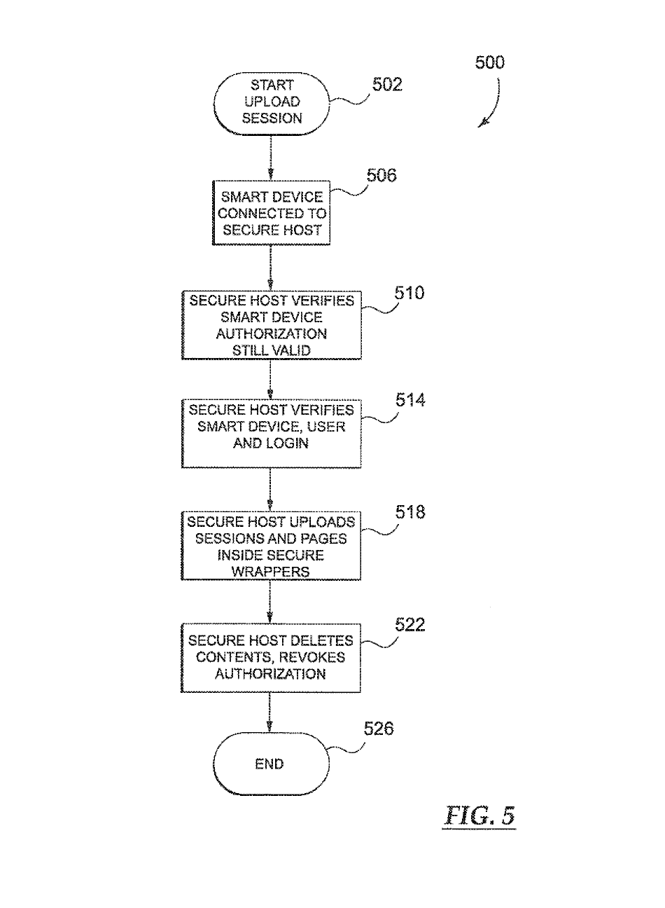

FIG. 3-5 provide flowcharts of the three phase process and method used to create and collect secure electronic records. FIG. 3 shows the setup phase, FIG. 4 shows the use phase, while FIG. 5 illustrates the upload phase.

FIG. 3 shows the steps of the setup process, 300. The setup process begins at step 302. During the setup phase the smart device 104a-c is supplied with the specific software, tokens, credentials and authorization to use the device. In step 306 the smart device connects with the secure host 108. When initially connected, the smart device 104a-c requests a device connection from the secure host 108 and once that connection is established, the smart device 104a-c reports its presence by sending a token. The token may be a unique device identity that allows for each smart device to be readily verified and known by the secure host. The secure host may maintain a list of smart devices for use in the secure environment. Alternatively, a smart device signature may be generated using an encrypted token that may be generated or stored on the smart device. This encryption may be accomplished through the use of a commercial encryption algorithm, such as Rivest-Shamir-Adleman (RSA), however, any encryption method may he used. The connection between the host computer 108 and the smart device 104a-c may be accomplished through the use of a number of device connection protocols, including but not limited to USB, Bluetooth, and WIFI. This exchange over the connection initiates the smart device 104a-c authorization, step 310. It is also possible to detect and prevent security violations even at this early stage of the process as the secure host 108 may prevent connection of an unauthorized, tampered, or malevolent smart device, by rejecting the device token and presenting an error or violation message.

Once the smart device 104a-c is connected and accepted by the secure host 108, the smart device 104a-c is loaded with at least one user credential for the upcoming formal record creation or collection session. The user credential mayor may not be the same as that used on the secure host computer 108. This credential is protected by the use of a one-way public key encryption that allows for comparison with user input during the validation phase. This prevents exposure of the user credentials by the smart device 104a-c.

As part of the authorization process the secure host 108 loads software on the smart device 104a-c, as indicated in step 314. This software may be an assembly language program, an applet for a smart phone, or any other format supported by the smart device selected for use. The software incorporates internal validation processes and may also perform integrity checks on the smart device. It is this software that disables the smart device if the smart device is connected to any device other than the authorizing secure host.

The smart device 104a-c is authorized for a specific use, typically secure data record connection in step 316. Additional requirements for the particular use may also be included, such as a specific frequency of record collection, specific metadata to be collected, and an expiration time. The smart device 104a-c is generally authorized for a specific and limited period of time, after which a timeout occurs and data collection is prohibited by the smart device. Date and time information on the smart device 104a-c are also verified and corrected, and the condition of the device necessary to maintain its orientation is also verified. Depending on the nature of the smart device 104a-c, further information beyond that date and time are available and may also serve as useful metadata to establish the integrity of the data records collected.

Once the smart device 104a-c has been authorized, the device is ready for use, in step 320 and the setup process ends in step 324. Upon completion of the authorization process, the smart device 104a-c is secure and protected from unauthorized use. The smart device software is ready to collect or create records and successfully encrypt, secure and protect the collected records.

FIG. 4 provides a flowchart of the secure smart device 104a-c in use. The process, 400, begins at step 402. The record collection session begins when the user logs into the smart device 104a-c, in step 402, to validate that the user is permitted to use the device. This user validation typically consists of a user logging in with a user name or password provided by the existing secure environment, 202. The smart device 104a-c may have various ways of receiving entries from users. The user may enter the information via a keypad, a touch stylus on a tablet, supply a thumbprint or fingerprint, or may provide a voice print. It is conceivable that a retina scan may be used as well. If a touch stylus is used, direct entry of the user's signature may provide the log in for user validation. The smart device 104a-c may record each access attempt for security purposes. For additional security, a secondary validation may be required by the secure environment 202. This secondary validation may be processed later by secure host 108 during the uploading of data from the smart device 104a-c, upon completion of the record collection session. The secondary validation may take any of the forms of validation above and for added security different forms of validation may be selected. Based on the validation information provided by the user, the smart device 104a-c then calculates and pre-authorizes a session for that user on that smart device 104a-c. This pre-authorization process creates a token to be used for secure encryption of the formal electronic record being created.

The user then begins creating a formal record using the smart device 104a-c. The user may access pre-printed forms, such as laboratory report forms, on the smart device 104a-c in step 410. The smart device 104a-c initiates a timer or clock when secure electronic record creation or collection begins in step 414. Each smart device 104a-c is authorized for a specific period of time to collect secure electronic records and ceases to allow record creation once the timer or clock has expired. While the user is creating secure electronic records, the smart device 104a-c process each record or page by wrapping each record in a secure wrapper as indicated in step 418. The smart device 104a-c applies hashing, such as SHA-1 hashing, to the records and may further encrypt the data for additional security. Each data record is contained in a wrapper, which may be in XML format, so that relevant metadata is included for each record. This allows for secure electronic records to be tied to a particular smart device 104a-c and a particular user. The records may be an audio recording, scan of a written page, pen stokes of a smart pen, bar codes for inventory data, visual images from a camera, magnetic stripe data as found on credit cards, RFID tags, or a combination of data types. The smart device 104a-c may also provide for annotations on each secure electronic record as it is created. These annotations may be in the form of voice notes or notes made with a smart pen. This process occurs during the time that the smart device 104a-c is disconnected and independent from the existing secure environment 202. During the secure record collection and creation process, the smart device 104a-c will not allow deletion of secure electronic records by the user.

Collection of secure electronic records may be modified from that described above, based on the needs of the record user. Authentication and non-repudiation are accomplished through the use of the software contained on the smart device 104a-c. The software on the smart device 104a-c validates itself before operation and use, which assures continued operation. This allows for programming flexibility, such as providing a playback feature to allow smart device users to check a collected secure record before leaving a remote record storage location. This would be especially helpful for record collection at off-site storage locations, where returning may not be possible.

Upon completion of a secure electronic record the smart device 104a-c checks whether the device is still in use, step 422. This is useful in case the user walks away from the device or sets it down temporarily. The smart device 104a-c will then check to see if the timeout clock expired, in step 430. If the timeout clock has not expired, the user may make another record as provided in step 426. The process repeats as long as the user continues to create secure electronic records and the timeout clock has not expired. If the timeout clock has expired, the smart device 104a-c authorization expires in step 434. With the expiration of the authorization, the smart device 104a-c may not be used and the process ends in step 438.

FIG. 5 details the steps in the uploading process, 500. Once the secure electronic records have been collected the records must be transferred to the existing secure environment, 202. In step 502 an upload session begins. The smart device 104a-c is reconnected to the existing secure environment, 202 in step 506. Upon connection, the secure host 108 verifies that the smart device 104a-c is a previously authorized data collection device. The smart device 104a-c may also report to the secure host 108 using a unique token. The unique identity of the smart device 104a-c is checked against a list of authorized smart devices 104 a-c maintained on the secure host 108. The secure host has a record of all authorized devices and their expected data collection activities. This allows for detection of exceptions to the list of smart devices .104a-c. An exception may be a smart device 104a-c that failed to return to the secure environment during a preauthorized period, or a device that detected tampering, a login failure, or other potentially malevolent activity. During the connection to the secure host 108, the smart device 104a-c reports its user credentials, allowing a report to be generated indicating which users successfully recorded secure electronic records. This forms a type of security log for the smart device 104a-c. For additional security the smart device 104a-c may be required to return to the same secure host 108 that authorized the device for any uploading.

In step 510 the secure host 108 verifies that the smart device 104a-c authorization is still valid. The secure host 108 then verifies the user, and the user's login information in step 514. Once the smart device 104a-c has been successfully connected and verified the uploading of the secure electronic records from the device begins in step 518. The uploading process also requires that the secure host 108 decrypt the wrapper added to the secure electronic record at the time of collection. Each record on the smart device 104a-c is encrypted in such a way that the record cannot be decrypted while resident on the smart device 104a-c. The secure electronic record must be decrypted with a private key maintained on the secure host 108. If playback capability on the smart device 104a-c is desired, playback capability may be achieved through the use of redundant information kept on the smart device 104a-c in an unencrypted file. This provides for secure and uncorrupted records transmission to the existing secure environment, 202.

If any secondary security procedures were implemented during secure electronic record collection those operations are also processed by the secure host 108 during the upload process. The results of the secondary security procedures may be used to enhance the validity of the collected information.

Once all collected secure electronic records have been uploaded to the secure host 108, the secure host 108 clears the smart device 104a-c of records, revokes the authorization, and returns the smart device 104a-c to a setup state in step 522. The uploading process concludes at step 526.

An additional embodiment of the invention is the application of secure recordkeeping to research conducted on large databases, typically over the Internet 204, using a browser. The research conducted may be augmented with secure recordkeeping using a laptop or other computer and is kept separate from the existing secure environment 202. This embodiment may be implemented as a module or software plug-in to standard web browser functionality.

Thus, it is seen that a method and apparatus for secure electronic record creation in smart devices is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to various partitions. Additionally, in regard to flow diagrams, operational description and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the inventions, whether or not such embodiments are described and whether or not such features are presented as being a part of a described embodiment. Thus, the breadth and scope of the present invention should not be limited by any of the above-described embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, tradition, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is expressly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The techniques described herein may be implemented by various means. For example, these techniques may be implemented in hardware, firmware, software, or a combination thereof For a hardware implementation, the processing units may be implemented within one or more application specific integrated circuits (ASICS), digital signal processors (DSPs), digital signal processing devices, (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a software implementation, the techniques may be implemented with instructions (e.g. procedures, function, and so on) that perform the functions described herein. The instructions may be stored in a memory in the secure host 108 or the smart device 104a-c. The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method comprising:
authorizing a smart device;
verifying a user of the smart device;
collecting an electronic record using the smart device;
creating an encrypted wrapper for the electronic record collected with the smart device to create a secure electronic record; and
uploading the secure electronic record to a secure host.

2. The method of claim 1, wherein authorizing a smart device results in authorization for a specific period of time.

3. The method of claim 1, wherein authorizing a smart device results in authorizing a specific type of smart device.

4. The method of claim 1, wherein verifying a user of the smart device requires input from the user.

5. The method of claim 4, wherein the input is a password.

6. The method of claim 4, wherein the input is a keypad entry.

7. The method of claim 4, wherein the input is a stylus signature.

8. The method of claim 4, wherein the input is a fingerprint.

9. The method of claim 4, wherein the input is a voice print.

10. An apparatus for creating secure electronic records, comprising:
a memory; and
a processor coupled with the memory, the processor configured to authorize a smart device, verify a user of the smart device, collect an electronic record, encrypt the electronic record to create a wrapper for the electronic record, and upload the electronic record to a secure host.

11. The apparatus of claim 10, wherein authorizing a smart device results in authorization for a specific period of time.

12. The apparatus of claim 10, wherein authorizing a smart device results in authorizing a specific type of smart device.

13. The apparatus of claim 10, wherein verifying a user of the smart device requires input from the user, the processor configured to accept such input from the user.

14. The apparatus of claim 13, wherein the input is a password.

15. The apparatus of claim 13, wherein the input is a stylus signature.

16. The apparatus of claim 13, wherein the input is a fingerprint.

17. The apparatus of claim 13, wherein the input is a voiceprint.

18. An apparatus comprising:
means for authorizing a smart device;
means for verifying a user of the smart device;
means for collecting an electronic record using the smart device;
means for creating an encrypted wrapper for the electronic record collected with the smart device to create a secure electronic record; and
means for uploading the secure electronic record to a secure host.

19. A processor readable medium including instructions thereon that may be utilized by one or more processors, the instructions comprising:
instructions for authorizing a smart device;
instructions for verifying a user of the smart device;
instructions for collecting an electronic record using the smart device;
instructions for creating an encrypted wrapper for the electronic record collected with the smart device to create a secure electronic record; and
instructions for uploading the secure electronic record to a secure host.
